(19) United States
(12) Patent Application Publication
(10) Pub. No.: US 2009/0299860 A1
(43) Pub. Date: Dec. 3, 2009

(54) Method and System for Creating Dynamic Advertisements

(75) Inventors: Samuel J. Yount, St. Louis, MO (US); Kevin C. Dodson, Brentwood, MO (US)

Correspondence Address: THOMPSON COBURN LLP, ONE US BANK PLAZA, SUITE 3500, ST LOUIS, MO, 63101, US

(73) Assignee: Scottrade, Inc., St. Louis, MO (US)

(21) Appl. No.: 12/129,073

(22) Filed: May 29, 2008

(51) Int. Cl. G06Q 30/00; G06F 17/30; G06F 7/06

(52) U.S. Cl. 705/14.73; 707/5; 707/E17.014

(57) ABSTRACT

A method and system for receiving an inputted request for information related to a financial instrument from a user with a first processor, where the request includes a financial instrument identifier. The request is processed to identify the financial instrument identifier. A plurality of data representative of a financial instrument associated with the financial instrument identifier is provided with at least one second processor. A dynamic advertisement is generated based on the received plurality of data. Preferably, the generated dynamic advertisement further includes a chart and text associated with the financial instrument. Preferably, the inputted request for information related to a financial instrument includes a Uniform Resource Locator (“URL”) that includes a query string and the query string includes the financial instrument identifier. Preferably, the logic necessary to process the request for information related to a financial instrument is contained within the computer code that represents the advertisement. This generated dynamic advertisement can be a banner advertisement.

### BACKGROUND OF INVENTION

Internet advertising is an extremely important method of attracting customers to a business. This is especially true for an online business. Internet advertisements can take many forms. One common type of advertisement is known as a “banner advertisement” or “banner ad.” Banner advertisements typically include graphics and/or text and a link to a website hosted by the business being advertised, such that when the user selects the banner ad, e.g., by clicking on the banner with a mouse pointer, the user's browser can navigate to the website of the host business. Typically, banner advertisements are hosted by a website which offers services to users and generates revenue through advertising. Yahoo® Finance and MSN® Money are two examples of advertising hosts. Yahoo® is a federally registered trademark of Yahoo! Inc. having a place of business at 701 First Avenue, Sunnyvale, Calif. 94089 and MSN® is a federally registered trademark of Microsoft Corporation having a place of business at One Microsoft Way, Redmond, Wash. 98052-6399.

Typically, the host company designates a fixed advertisement area on the host page, and rotates banner advertisements from multiple advertisers through the advertisement area. Therefore, banner ads are typically created to conform to a specific shape having a particular pixel resolution. Typically, a plurality of pieces of computer code capable of generating banner ads are stored in a database, and the host page is configured to select a banner ad from the database based on predetermined criteria, and insert that banner ad's computer code into the host web page code. For example, the host page may insert a particular advertisement with a predetermined frequency that is based on the amount of money paid by a particular advertiser. It is convenient if the programming of the banner ad is “self-contained,” i.e., does not require any modification to the host page.

Traditional banner advertisements are typically “static” in that a given banner ad does not change depending on the content of the host page. Many host pages are dynamic in the sense that they are responsive to user input. Such dynamic host pages present an opportunity to provide dynamic advertisements which are also responsive to user input. This allows dynamic advertisements to be tailored toward a user's interests, thereby providing a “targeted” advertising. Such targeted advertising is believed to be more effective than non-targeted advertising. The lack of dynamic advertising creates serious problems that result in the presence of ineffective and annoying advertising for the customer, which wastes the monetary resources of the advertiser.

The present invention is directed to overcome one or more of the problems as set forth above.

### SUMMARY OF INVENTION

The present invention pertains generally to the field of creating dynamic advertisements for display over the internet.

In one aspect of this invention, a dynamic advertisement is programmed to dynamically determine its own content.

In another aspect of this invention, a dynamic advertisement is inserted into a host page.

In another aspect of this invention, a dynamic advertisement is programmed to process a URL passed to the host page.

In another aspect of this invention, a dynamic advertisement is programmed to process a query string passed to the host page.

In another aspect of this invention, the host page preferably includes a page within a financial website.

In another aspect of this invention, the query string that is passed to the host page preferably includes a financial instrument identifier, e.g., stock ticker symbol.

In yet another aspect of this invention, the dynamic advertisement preferably includes an advertisement for financial instrument trading or investing services.

In still another aspect of this invention, the dynamic advertisement preferably processes the query string to identify a financial instrument identifier, e.g., stock ticker symbol.

In still yet another aspect of this invention, the generated dynamic advertisement preferably includes financial instrument-specific content relevant to the financial instrument identifier, e.g., stock ticker symbol.

In another aspect of the present invention, financial instrument-specific content preferably comprises graphics and text related to the financial instrument identifier, e.g., stock ticker symbol.

In still another aspect of the present invention, the dynamic advertisement may include a hyperlink to the advertiser's website such that when a user clicks on the dynamic advertisement, the user is taken to a page on the advertiser's website.

These are merely some of the innumerable aspects of the present invention and should not be deemed an all-inclusive listing of the innumerable aspects associated with the present invention. These and other aspects will become apparent to those skilled in the art in light of the following disclosure and accompanying drawings.

### BRIEF DESCRIPTION OF DRAWINGS

For a better understanding of the present invention, reference may be made to the accompanying drawings in which:

FIG. 1 shows a block diagram depiction of a preferred embodiment of the present invention for creating dynamic advertisements;

FIG. 2 shows an exemplary host page which provides a user-input area where the user can input a symbol corresponding to a financial instrument for which information is desired;

FIG. 3 shows an exemplary Uniform Resource Locator (“URL”) that is created by the host page of FIG. 2, including a query string;

FIG. 4A shows an exemplary host page which provides a financial instrument identifier, e.g., stock, information based on a user-inputted financial instrument symbol, e.g., stock ticker;

FIG. 4B shows the lower portion of the host page of FIG. 4A, including an advertisement area;

FIG. 5 shows an exemplary dynamic advertisement according to an embodiment of the present invention, wherein the financial instrument, e.g., stock, specific content pertains to Apple, Inc., having a place of business at 1 Infinite Loop, Cupertino, Calif. 95014;

FIG. 6A shows an exemplary advertiser web page;

FIG. 6B shows a lower portion of exemplary advertiser web page found in FIG. 6A;

FIG. 7 shows an exemplary dynamic advertisement according to an embodiment of the present invention, wherein the financial instrument, e.g., stock, specific content pertains to Intel Corporation, having a place of business at 2200 Mission College Blvd., Santa Clara, Calif. 95054-1549; and

FIG. 8 shows an exemplary dynamic advertisement according to an embodiment of the present invention, wherein the financial instrument identifier, e.g., stock, specific content pertains to Microsoft Corporation, having a place of business at One Microsoft Way, Redmond, Wash. 98052-6399.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. Additionally, the present invention contemplates that one or more of the various features of the present invention may be utilized alone or in combination with one or more of the other features of the present invention.

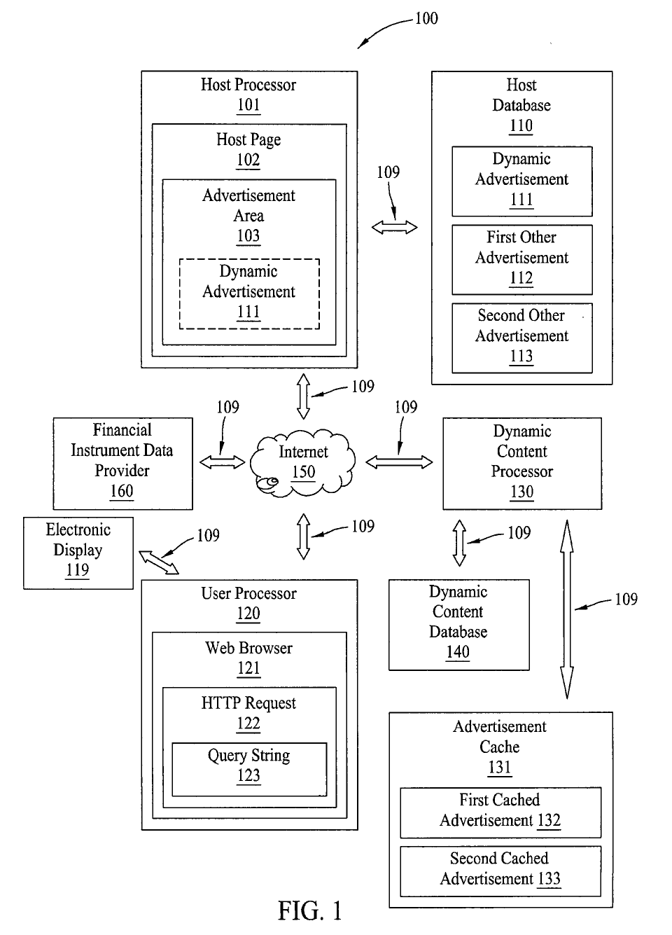

FIG. 1 shows a block diagram depiction of a preferred embodiment, which is generally indicated by numeral 100. There is a host processor 101 that is connected to the Internet 150. The host processor 101 preferably includes a web server configured to make at least one host page 102 available over the Internet 150. However, any of a wide variety of computers, processors, programmable logic controllers, and other types of computing mechanisms can suffice for the host processor 101. A processor, as the term is used herein, includes, without limitation, a multi-core processor or a plurality of processors. The host page 102 preferably includes at least one advertisement area 103 which comprises a reserved space on the host page 102 for insertion of an advertisement, e.g., a dynamic advertisement 111.

A host database 110 preferably comprises a computer database configured to store multiple advertisements. The host processor 101 is in communication with host database 110 as shown by the bi-directional arrows 109 in FIG. 1, which are used throughout FIG. 1 to indicate any method of computer-implemented communication, including, for example, communication over an Ethernet or TCP/IP network. The host database 110 may reside on the host processor 101 or on a separate processor, e.g., a dedicated database server, connected by a local area network or other communication means. Although a dedicated database server is preferred, any of a wide variety of computers, processors, programmable logic controllers, and other types of computing mechanisms can suffice for the host database 110.

A user processor 120 is connected to the Internet 150. The user processor 120 includes a web browser 121. The user processor 120 is in communication with the host processor 101 via the Internet 150. The web browser 121 is configured to send an HTTP request 122 to the host processor 101. The HTTP request 122 preferably includes a request for a host page 102, which is available on the host processor 101, and a query string 123. The query string 123 preferably includes a financial instrument identifier, e.g., stock ticker symbol, which has preferably been provided as input by the user. A financial instrument includes any instrument having monetary value or recording a monetary transaction. Illustrative, but nonlimiting, examples include stocks, bonds, mutual funds, derivatives and futures. Any of a wide variety of computers, processors, PCs, servers, programmable logic controllers, and other types of computing mechanisms can suffice for the user processor 120. In this patent application, the computing functionality of the user processor 120 is designated as being a first processor with the preferred embodiment being a personal computer. The user processor 120 is electrically connected to an electronic display 119. The electronic display 119 can include, but is not limited to, cathode ray tubes, electro-luminescent, flip-dot, incandescent light bulbs, liquid crystal, light emitting diode, organic light emitting diodes, polymer light emitting diodes, glow discharge, plasma display panels, and vacuum fluorescent displays among others types of electronic displays.

When the host page 102 is requested by the user processor 120, the host processor 101 selects an advertisement according to predetermined logic (as is known in the art), and sends a request for the selected advertisement to the host database 110. The predetermined logic can consider criteria such as the rotation frequency that an advertiser has previously purchased. It will be apparent that the host database 110 can be configured to store a large number of advertisements. The selected advertisement could be dynamic advertisement 111, or a first other advertisement 112 or a second other advertisement 113. The host database 110 then delivers the selected advertisement (or more precisely, the computer code representing the selected advertisement) to the host processor 101. The host processor 101 preferably populates advertisement area 103 in host page 102 with the selected advertisement. Preferably, the selected advertisement is a dynamic advertisement 111.

The dynamic advertisement 111 preferably contains dynamic advertisement code that is operable to process the query string 123 to locate a financial instrument identifier, e.g., stock ticker symbol, within the query string 123. The computer code in dynamic advertisement 111 is preferably “client-side” code, which is executed by the user processor 120, but can also be “server-side” code which is executed by the host processor 101. The host processor 101 sends the host page 102 to the user processor 120 via the Internet 150. The host page 102 is then rendered (displayed) on the electronic display 119 that is electrically connected to the user processor 120 by the web browser 121. In an embodiment wherein the the computer code in dynamic advertisement 111 is “client-side” code, the web browser 121 preferably directs the user processor 120 to execute the dynamic advertisement code contained in dynamic advertisement 111. The dynamic advertisement code can include JavaScript® code, FLASH®, or other programming language (client-side or server-side), as is known in the art. JavaScript® is a federally registered trademark of Sun Microsystems, Inc., having a place of business at 4150 Network Circle, Santa Clara, Calif. 95054. FLASH® is a federally registered trademark of Adobe Systems Incorporated, 345 Park Avenue, San Jose, Calif. 95110.

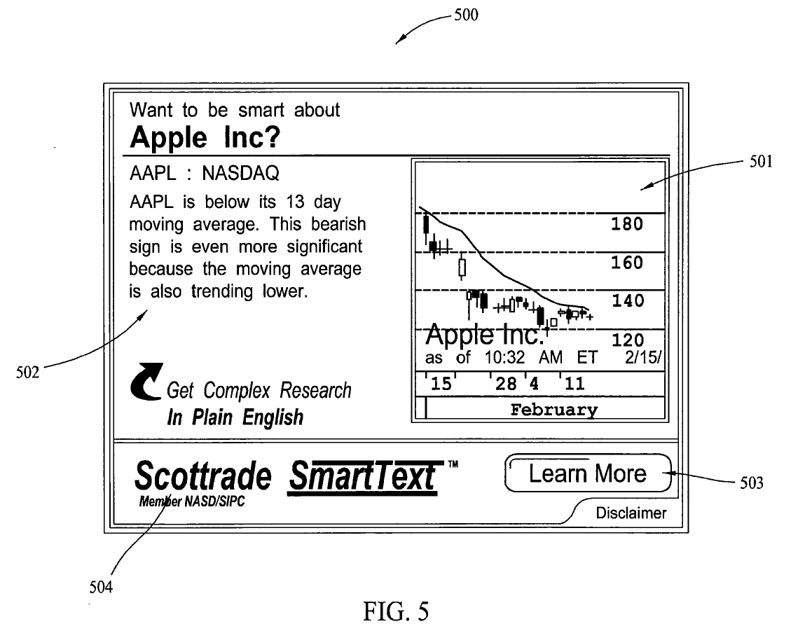

The dynamic advertisement code processes the query string 123 and then locates a financial instrument identifier, e.g., stock ticker symbol, contained therein. The dynamic advertisement code then transmits the financial instrument identifier, e.g., stock ticker symbol, to a dynamic content processor 130 via the Internet 150. The dynamic content processor 130 is connected to the Internet 150, a dynamic content database 140, and an advertisement cache 131. When the dynamic content processor 130 receives a financial instrument identifier, e.g., stock ticker symbol, the dynamic content processor 130 can dynamically generate an advertisement that is tailored to that specific financial instrument identifier, e.g., stock ticker symbol. The generated advertisement preferably includes a banner advertisement as shown in FIG. 5 that is generally indicated by numeral 500. The advertising cache 131 is capable of storing a plurality of generated advertisements, e.g., a first cached advertisement 132 and a second cached advertisement 133. The dynamic content processor 130 is preferably a server; however, any of a wide variety of computers, processors, programmable logic controllers, and other types of computing mechanisms can suffice.

Before generating a new advertisement, the dynamic content processor 130 preferably checks the advertising cache 131 to determine whether an advertisement has been previously created for the requested financial instrument identifier, e.g., stock ticker symbol. If an advertisement has been generated recently for this specific financial instrument identifier, e.g., stock ticker symbol, then the dynamic content processor 130 will use the first cached advertisement 132 in the advertising cache 131 instead of generating a new advertisement. Preferably, the dynamic content processor 130 will use an advertisement from the advertising cache 131 if a first cached advertisement 132 is of a predetermined period of time old, e.g., fifteen (15) minutes, or less. If the first cached advertisement 132 for the requested financial instrument identifier, e.g., stock ticker symbol, is older than a predetermined period of time, e.g., fifteen (15) minutes, or if no cached advertisement present in advertising cache 131 for the requested financial instrument, e.g., stock, then the dynamic content processor 130 is configured to generate a new advertisement, e.g., a second cached advertisement 133. The dynamic content processor 130 acquires the financial instrument, e.g., stock, price data for the requested financial instrument, e.g., stock, from dynamic content database 140, either periodically, or upon receiving a request to generate a new advertisement.

The dynamic content processor 130 is configured to use the acquired financial instrument, e.g., stock, price data to automatically generate a chart that displays the data in a graphical format. Moreover, the dynamic content processor 130 is further configured to generate text based on the acquired financial instrument, e.g., stock, price data. The generated text is preferably an explanation of the financial instrument, e.g., stock, price data. The dynamic advertisement preferably includes the generated chart and text. The dynamic content processor 130 then makes the generated advertisement available over the Internet 150.

The dynamic content processor 130 also preferably stores the newly generated advertisement in the advertisement cache 131 for later access. The dynamic advertisement 111 is configured to incorporate the generated advertisement from the dynamic content processor 130 as the content of dynamic advertisement 111. Preferably, the web browser 121 displays the host page 102, which includes the advertisement area 103 and the dynamic advertisement 111. The dynamic advertisement 111 preferably includes the generated advertisement. The advertisement area 103 is preferably a larger area on the host page 102 than the generated advertisement dynamic advertisement 111. Preferably, the dynamic advertisement 111 is displayed on user processor 120 without any indication that the source of the advertisement is the dynamic content processor 130 and not the host processor 101.

The dynamic content processor 130 can be operated by the advertiser or by a third-party. A variety of online content providers offer such a service, including WALL STREET ON DEMAND® and a variety of others. WALL STREET ON DEMAND® is a federally registered trademark of Wall Street On Demand, Inc., having a place of business at 3 Times Square, New York, N.Y. 10036.

The dynamic content processor 130 is in electronic communication with a financial instrument, e.g., stock, price data provider 160 via the Internet 150. The dynamic content processor 130 periodically receives financial instrument, e.g., stock, price data from the financial instrument, e.g., stock, price data provider 160 and then updates the dynamic content database 140 to reflect the received financial instrument, e.g., stock, price data. Preferably, dynamic content processor 130 receives financial instrument, e.g., stock, price data for each financial instrument, e.g., stock, on a wide variety of stock exchanges, e.g., NASDAQ®, NYSE®, among others. NASDAQ® is a federally registered trademark of Nasdaq Stock Market, Inc., having a place of business at One Liberty Plaza, 165 Broadway, New York, N.Y. 10006. NYSE® is a federally registered trademark of New York Stock Exchange, Inc., having a place of business at 11 Wall Street, New York, N.Y. 10005. The financial instrument, e.g., stock, price data provider 160 is preferably a server; however, any of a wide variety of computers, processors, programmable logic controllers, and other types of computing mechanisms can suffice.

Preferably, the dynamic content processor 130 receives financial instrument, e.g., stock, price data for each financial instrument, e.g., stock, after a predetermined period of time, e.g., fifteen (15) minutes, or less. Alternatively, the dynamic content processor 130 could request financial instrument, e.g., stock, price data for a particular financial instrument, e.g., stock, in response to a request for an advertisement for that particular financial instrument, e.g., stock.

The functionality of the host processor 101, the dynamic content processor 130 and the financial instrument data provider 160 can be combined to reside on two or less computing mechanisms. In this patent application, the computing functionality of the host processor 101 and associated host database 110, the dynamic content processor 130 and associated dynamic content database 140 and advertising cache 131, and the financial instrument data provider 160 can be designated as being at least one second processor.

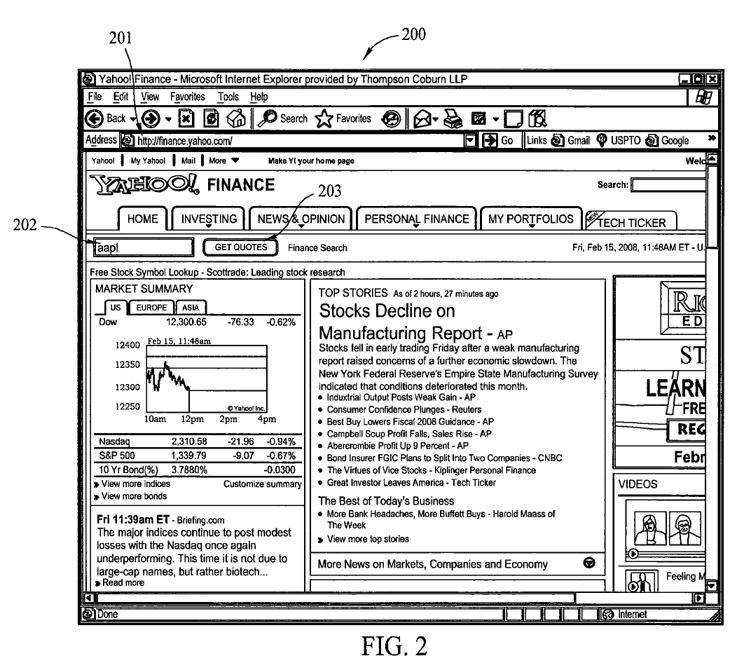

The preferred embodiment can be further understood through the following example. For example, assume that the user of user processor 120 desires information related to Apple Inc. The user might use web browser 121 to access a financial website, e.g., Yahoo® Finance at URL: http://finance.yahoo.com. Upon directing the web browser 121 to this address, the user is presented with the financial website shown in FIG. 2, which is indicated generally by numeral 200. The address bar 201 displays the current Uniform Resource Locator (“URL”) address of the displayed page. The financial website 200 includes a ticker symbol input field 202. The user can enter a ticker symbol and click the “GET QUOTES” pushbutton 203 to initiate a search for information related to that ticker symbol. In this example, the user desires information related to Apple Inc. The financial instrument, e.g., stock, ticker symbol “aapl” corresponds to Apple Inc. The user enters “aapl” into input box 202 and clicks on the “GET QUOTES” pushbutton 203. In response to this exemplary search request, an exemplary HTTP Request 122, as shown in FIG. 1, would include the URL: http://finance.yahoo.com/q?s=aapl.

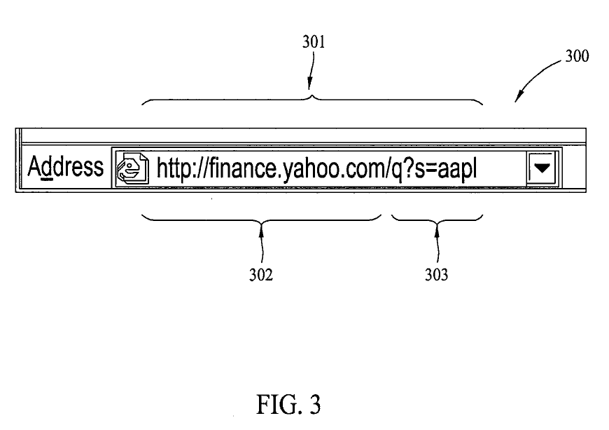

FIG. 3 shows an exemplary Uniform Resource Locator (“URL”), which is generally indicated by numeral 300. There is an exemplary URL 301 that includes an exemplary server address 302 and an exemplary query string 303. The previously discussed query string 123, from FIG. 1, could be this exemplary query string 303.

Referring now to FIGS. 1 and 3, in this illustrative, but nonlimiting, example, exemplary query string 303 is equal to: q?s=aapl. In this example, the host processor 101 receives the exemplary query string 303 and then passes the exemplary query string 303 along to web server software, which is preferably resident on the host processor 101, but could reside on another processor in communication with the host processor 101. The host page 102 then receives the exemplary query string 303. As previously stated, the host page 102 is typically a dynamic page itself, as is known in the art.

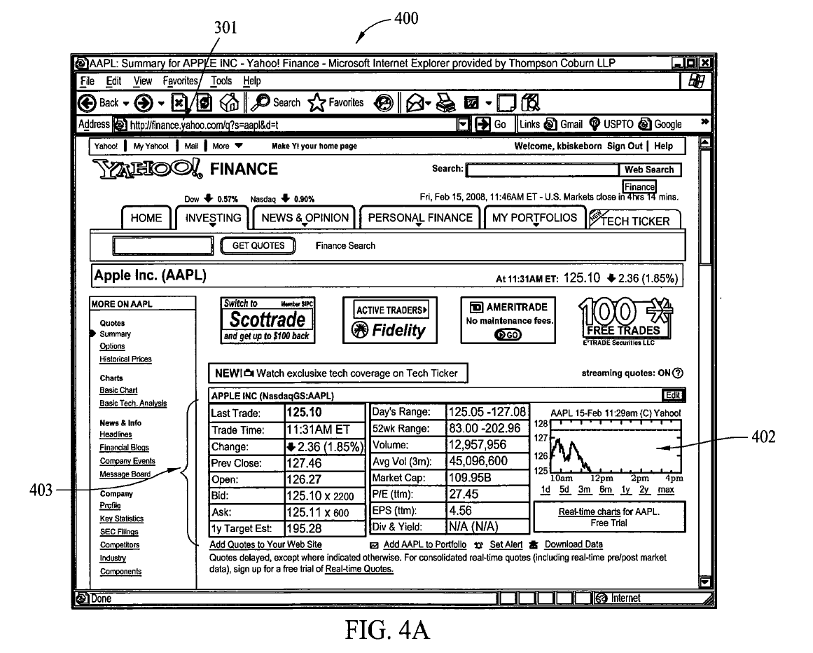

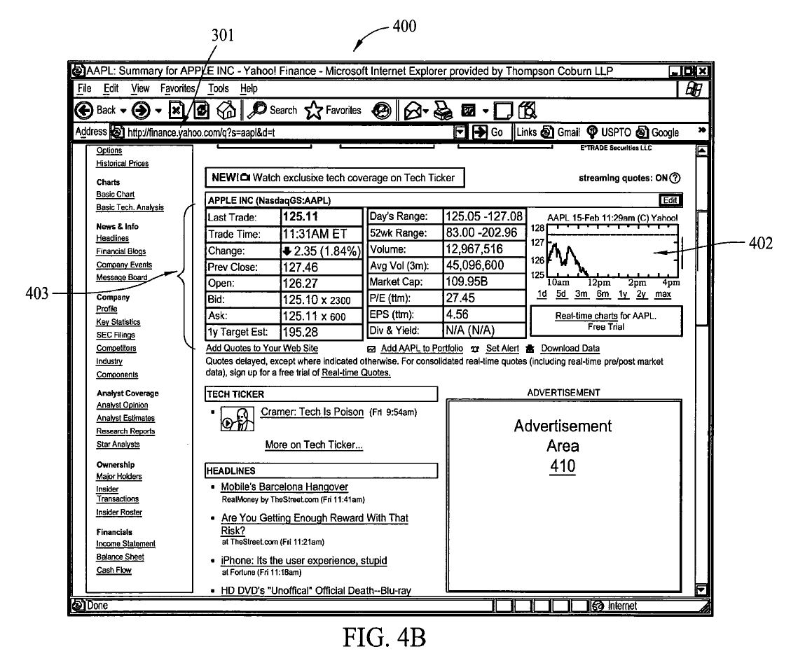

FIG. 4A shows an exemplary Yahoo® Finance page, which is generally indicated by numeral 400. Moreover, the previously referenced host page 102, from FIG. 1, could be this Yahoo® Finance page 400. Moreover, the Yahoo® Finance page 400 is configured to display near real-time information relevant to APPLE® in response to the exemplary query of FIG. 3. Yahoo Finance page 400 displays information relevant to APPLE® in chart 402 and in text 403. APPLE® is a federally registered trademark of Apple, Inc., having a place of business at 1 Infinite Loop, Cupertino, Calif. 95014.

FIG. 4B shows the lower portion of exemplary Yahoo® Finance page, which is generally indicated by numeral 400. The exemplary Yahoo® Finance page 400 also includes an exemplary advertisement area 410. Moreover, the previously referenced advertising area 103, from FIG. 1, could be this illustrative, but nonlimiting, exemplary advertisement area 410. The exemplary advertisement area 410 includes a reserved space for the insertion of an advertisement, such as a dynamic advertisement 111, as shown in FIG. 1, according to an exemplary embodiment of the present invention. In the current illustrative, but nonlimiting, example, wherein the query is related to APPLE®, the Dynamic Advertisement could be the advertisement shown in FIG. 5, which is generally indicated by numeral 500.

FIG. 5 shows an exemplary dynamic banner advertisement 500, wherein the content is related to Apple, Inc. The previously referenced dynamic advertisement 111, shown in FIG. 1, could be the exemplary dynamic banner advertisement 500. The exemplary dynamic banner advertisement 500 processes the exemplary query string 303, shown in FIG. 3, and identifies the financial instrument, e.g., stock, ticker symbol “aapl.” The dynamic advertisement software code in exemplary dynamic banner advertisement 500 includes instructions to transmit the symbol “aapl” to the dynamic content processor 130, as shown in FIG. 1. As shown in FIG. 1, the dynamic content processor 130 then responds by checking the advertising cache 131 for a previously-generated advertisement related to APPLE®. If an APPLE® advertisement is present in the advertising cache 131, and is less than a predetermined period of time old, e.g., fifteen (15) minutes, then the dynamic content processor 130 will preferably respond to the HTTP request by delivering this first cached advertisement 132 related to APPLE®. If no APPLE® advertisement is present in the advertising cache 131 or if an existing APPLE® advertisement is a predetermined period of time old, e.g., fifteen (15) minutes, or more, then the dynamic content processor 130 will generate a new advertisement related to APPLE®.

Referring again to FIG. 1, in order to generate a new advertisement, the dynamic content processor 130 checks the dynamic content database 140 for financial instrument, e.g., stock, price data related to APPLE®. If the financial instrument, e.g., stock, price data related to APPLE® in the dynamic content database 140 is not present, or older than a predetermined period of time, e.g., fifteen (15) minutes, then the dynamic content processor 130 requests updated data related to APPLE® from the financial instrument, e.g., stock, data provider 160. The dynamic content processor 130 is preferably configured to analyze the data received and generate graphic charts and text based on this received data. The chart could be a simple line graph, a box chart or any of a wide variety of graphical representations. The text is preferably dynamically generated according to programming resident on the dynamic content processor 130. However, this is merely an example, and it will be apparent to one of ordinary skill in the art that the programming for generating the chart and text could be resident within the dynamic ad itself. Preferably, the dynamically generated text comprises an explanation of the recent financial instrument, e.g., stock, price data for the financial instrument identifier, e.g., stock ticker symbol, in question. Once the new APPLE®-related advertisement is generated, the dynamic content processor 130 responds to the HTTP request 122 by delivering the newly generated advertisement. Preferably, but not necessarily, the dynamic content processor 130 also stores the newly-generated advertisement, e.g., APPLE® advertisement, in the advertisement cache 131. The newly-generated advertisement can then over-write any existing advertisement related to that same entity, e.g., APPLE®, in the advertisement cache 131.

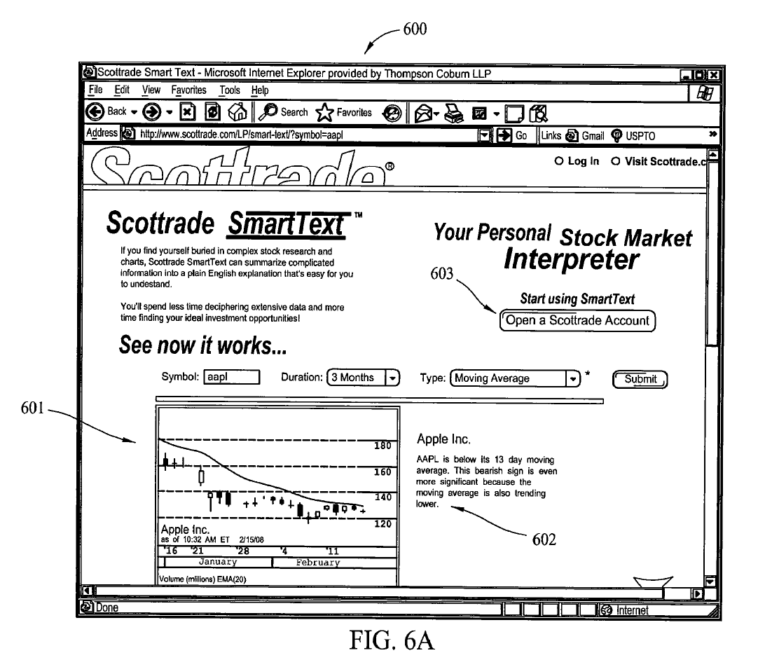

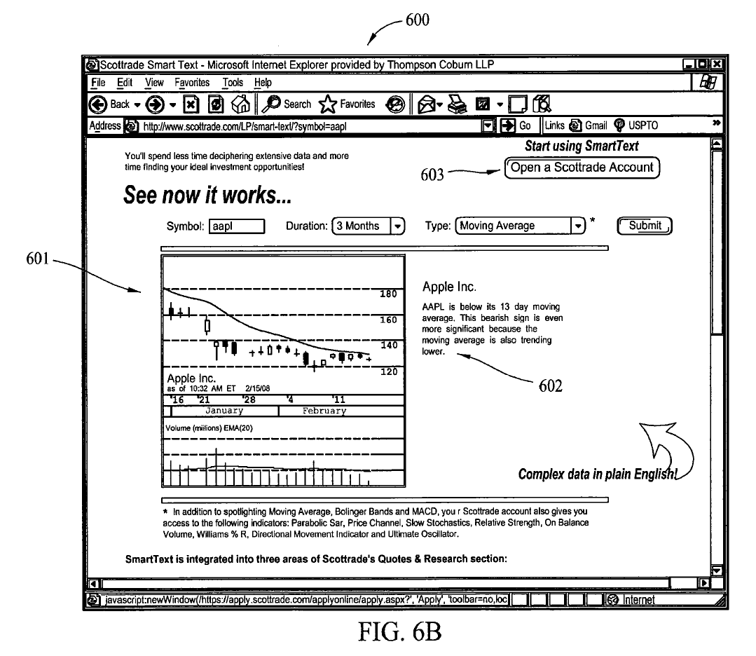

Referring again to FIG. 5, the exemplary dynamic banner advertisement 500 includes an exemplary chart 501 and an exemplary text 502. The exemplary chart 501 and the exemplary text 502 are preferably created and provided by previously referenced dynamic content processor 130, as shown in FIG. 1. The exemplary chart 501 shows the recent stock prices for Apple, Inc. The exemplary text 502 provides interpretation of various financial instrument, e.g., stock, data, including, but not limited to price. The exemplary text 502 comprises the words: “AAPL is below its 13 day moving average. This bearish sign is even more significant because the moving average is also trending lower.” This dynamic banner advertisement 500 also includes an advertiser logo 504 and a “Learn More” pushbutton 503 which comprises a hyperlink to the advertiser's website, e.g., SCOTTRADE®. SCOTTRADE® is a federally registered trademark of Scottrade, Inc., having a place of business at 12855 Flushing Meadows Drive, Suite 100, Saint Louis, Mo. 63131. Preferably, this hyperlink includes the financial instrument identifier, e.g., stock ticker symbol, so that the advertiser's web page can include further information specific to the financial instrument in question. Preferably, the hyperlink points to a dynamic web page such as that shown in FIGS. 6A and 6B that is generally indicated by numeral 600.

FIG. 6A shows the exemplary advertiser web page 600, which shows additional financial instrument, e.g., stock, specific information, which includes a chart 601 and text 602. The exemplary advertiser web page 600 also includes a pushbutton 603 for opening an account with the advertiser. Preferably, the advertiser is an online financial brokerage, such as Scottrade, Inc. FIG. 6B shows a lower portion of the same exemplary advertiser web page 600.

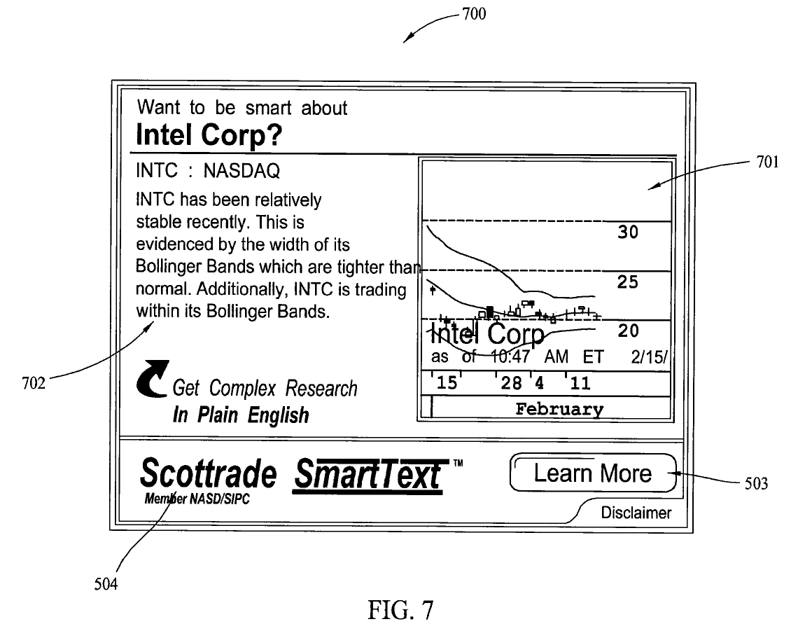

FIG. 7 shows another illustrative, but nonlimiting, exemplary dynamic advertisement, as previously referenced and shown in FIG. 1 as numeral 111, that is related to Intel Corporation that is generally indicated by numeral 700. This exemplary dynamic advertisement 700, e.g., banner advertisement, includes a dynamic chart 701 and dynamic text 702. The dynamic text 702 comprises the words “INTC has been relatively stable recently. This is evidenced by the width of its Bollinger Bands which are tighter than normal. Additionally, INTC is trading within its Bollinger Bands.”

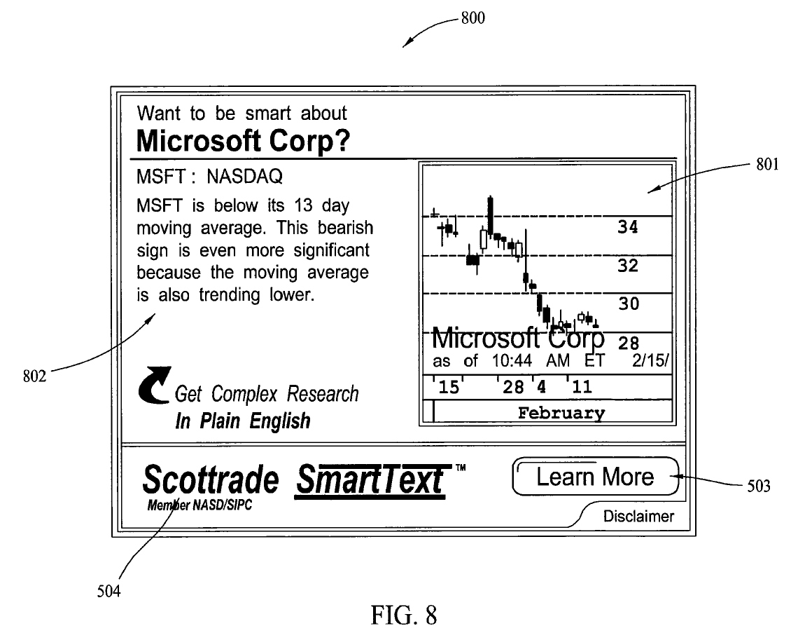

FIG. 8 shows yet another illustrative, but nonlimiting, exemplary dynamic advertisement, as previously referenced and shown in FIG. 1 as numeral 111, that is related to Microsoft Corporation and is generally indicated by numeral 800. The exemplary dynamic advertisement 800, e.g., banner advertisement, includes a dynamic chart 801 and dynamic text 802. The dynamic text 802 comprises the words “MSFT is below its 13 day moving average. This bearish sign is even more significant because the moving average is also trending lower.”

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “have,” “having,” “includes,” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims that follow.

1. A method for dynamically generating advertisements, the method comprising:
receiving an inputted request for information related to a financial instrument from a user with a first processor, wherein the request includes a financial instrument identifier;
processing the request to identify the financial instrument identifier based on logic contained within computer code representing a dynamic advertisement;
providing a plurality of data representative of a financial instrument associated with the financial instrument identifier with at least one second processor; and
generating the dynamic advertisement based on the computer code representing the dynamic advertisement and the received plurality of data.

2. The method for dynamically generating advertisements according to claim 1 wherein the step of processing the request to identify the financial instrument identifier is performed by the first processor.

3. The method for dynamically generating advertisements according to claim 1 wherein the step of generating the dynamic advertisement is performed by the at least one second processor.

4. The method for dynamically generating advertisements according to claim 1, further comprising displaying the generated dynamic advertisement on a host page shown on an electronic display that is electrically connected to the first processor.

5. The method for dynamically generating advertisements according to claim 4, wherein the generated dynamic advertisement appears within an advertising area on the host page.

6. The method for dynamically generating advertisements according to claim 4, wherein the generated dynamic advertisement is a banner advertisement.

7. The method for dynamically generating advertisements according to claim 1, wherein the inputted request for information related to a financial instrument from the user includes a Uniform Resource Locator (“URL”), wherein the Uniform Resource Locator (“URL”) includes a query string and the query string includes the financial instrument identifier.

8. The method for dynamically generating advertisements according to claim 7, wherein the processing step comprises processing the query string to identify a financial instrument identifier.

9. The method for dynamically generating advertisements according to claim 1, further utilizing a web browser to obtain the inputted request for information related to the financial instrument.

10. The method for dynamically generating advertisements according to claim 1, wherein the generated dynamic advertisement further includes a chart and text associated with the financial instrument.

11. The method for dynamically generating advertisements according to claim 10, wherein the generated dynamic advertisement further includes at least one of an advertising logo and a hyperlink to an advertiser's website.

12. The method for dynamically generating advertisements according to claim 1, wherein the generated dynamic advertisement includes an advertisement for at least one of a financial instrument trading service and a financial instrument investment service.

13. The method for dynamically generating advertisements according to claim 1, wherein the at least one second processor includes at least one of a host processor, a dynamic content processor and a financial instrument data provider.

14. A system for dynamically generating advertisements, the system comprising:
a first processor that receives a inputted request for information related to a financial instrument from a user, wherein the request includes a financial instrument identifier; and
at least one second processor to provide a plurality of data representative of a financial instrument associated with the financial instrument identifier and generate a dynamic advertisement based on the received plurality of data with the at least one second processor;
wherein the system is configured to process the request to identify the financial instrument identifier based on logic contained within computer code representing the dynamic advertisement.

15. The system for dynamically generating advertisements according to claim 14, wherein the first processor is configured to process the request to identify the financial instrument identifier.

16. The system for dynamically generating advertisements according to claim 14, wherein the at least one second processor is configured to process the request to identify the financial instrument identifier.

15. The system for dynamically generating advertisements according to claim 14, further comprising an electronic display that is electrically connected to the first processor that displays the generated dynamic advertisement on a host page.

16. The system for dynamically generating advertisements according to claim 15, wherein the generated dynamic advertisement is a banner advertisement.

17. The system for dynamically generating advertisements according to claim 14, wherein the inputted request for information related to a financial instrument from the user includes a Uniform Resource Locator (“URL”), wherein the Uniform Resource Locator (“URL”) includes a query string and the query string includes the financial instrument identifier.

18. The system for dynamically generating advertisements according to claim 17, wherein the first processor is configured to process the query string to identify a financial instrument identifier.

19. The system for dynamically generating advertisements according to claim 14, wherein the system further includes a web browser to obtain the inputted request for information related to the financial instrument.

20. The system for dynamically generating advertisements according to claim 14, wherein the generated dynamic advertisement further includes a chart and text associated with the financial instrument.

21. The system for dynamically generating advertisements according to claim 14, wherein the generated dynamic advertisement includes an advertisement for at least one of a financial instrument trading service and a financial instrument investment service.

22. The system for dynamically generating advertisements according to claim 14, wherein the at least one second processor includes at least one of a host processor, a dynamic content processor and a financial instrument data provider.

23. A system for dynamically generating advertisements, the system comprising:
a user processor that (1) receives an inputted request for information related to a financial instrument from a user, wherein the request includes a financial instrument identifier, and (2) processes the request to identify the financial instrument identifier based on logic contained within computer code representing a dynamic advertisement;
a host processor that is electronically connected to the user processor and a host database; and
a dynamic content processor electronically connected to the host processor, a dynamic content database, and an advertisement cache, wherein the dynamic content processor is configured to receive a plurality of data representative of a financial instrument associated with the financial instrument identifier from the dynamic content database and generate a dynamic advertisement based on the received plurality of data.

24. The system for dynamically generating advertisements according to claim 23, further comprising a financial data provider that is in electronic communication with the dynamic content processor to provide updated financial data information representative of the financial instrument.

25. A method for dynamically generating advertisements, the method comprising:
receiving an inputted request for information related to a financial instrument from a user with a first processor, wherein the request includes a financial instrument identifier;
processing the request to identify the financial instrument identifier based on logic contained within computer code representing a dynamic advertisement;
providing a plurality of data representative of a financial instrument associated with the financial instrument identifier with the at least one second processor; and
generating the dynamic advertisement based on the computer code representing the dynamic advertisement and the received plurality of data, the dynamic advertisement comprising a chart and text related to the financial instrument.
